(19) United States
(12) Patent Application Publication
(10) Pub. No.: US 2010/0062801 A1
(43) Pub. Date: Mar. 11, 2010

(54) DUAL-STANDBY MOBILE TERMINAL AND COMMUNICATION METHOD FOR THE SAME

(76) Inventors: Tae Ho KIM, Suwon-si (KR); Heon Yong Lee, Suwon-si (KR)

Correspondence Address: CHA & REITER, LLC, 210 ROUTE 4 EAST STE 103, PARAMUS, NJ, 07652, US

(21) Appl. No.: 12/498,449

(22) Filed: Jul. 7, 2009

(30) Foreign Application Priority Data
Sep. 9, 2008 (KR) 10-2008-0088873

(51) Int. Cl. H04M 1/00

(52) U.S. Cl. 455/552.1

(57) ABSTRACT

A dual-standby mobile terminal and communication method for the same are disclosed. The dual-standby mobile terminal includes first and second communication modules enabling simultaneous connection to different wireless communication networks. The first communication module sends, upon making a transition to conversation mode, a notification indicating a transmit frequency to be used in conversation mode. The second communication module sends a change request for the transmit frequency when for a fundamental frequency of the notified transmit frequency is equal to that of a receive frequency used in standby mode after reception of the notification. The first communication module performs, upon reception of the change request, a conversation mode operation with a newly selected transmit frequency.

### CLAIMS OF PRIORITY

This application claims the benefit of the earlier filing date, pursuant to 35 USC 119, to that patent application entitled “DUAL-STANDBY MOBILE TERMINAL AND COMMUNICATION METHOD FOR THE SAME” filed in the Korean Intellectual Property Office on Sep. 9, 2008 and assigned Serial No. 10-2008-0088873, the contents of which are incorporated herein by reference.

### BACKGROUND OF THE INVENTION

1. Field of the Invention

The present invention relates generally to a mobile terminal and, more particularly, to a dual-standby mobile terminal with two or more communication modules capable of simultaneously connecting to two or more different wireless communication networks and to a communication method for the same.

2. Description of the Related Art

With rapid advances in communication technologies, advanced mobile terminals provide diverse functions. In particular, recently developed dual-mode mobile terminals can receive services from two or more different wireless communication networks. When the user selects one of wireless communication networks for communication, a dual-mode mobile terminal can connect to the selected wireless communication network one at a time. However, the dual-mode mobile terminal may have difficulty in mode switching between two wireless communication networks.

To mitigate this inconvenience, dual-standby mobile terminals have been proposed that can simultaneously connect to two or more wireless communication networks. A dual-standby mobile terminal includes two or more communication modules to simultaneously connect to two or more wireless communication networks. The dual-standby mobile terminal can enter into conversation mode using one of the communication modules. That is, the dual-standby mobile terminal can easily perform mode switching between wireless communication networks.

However, in such a dual-standby mobile terminal, when one of the communication modules is in conversation mode, the reception sensitivity of the other communication module in standby mode may degrade. This can be caused by interference between a transmit signal used by one communication module in conversation mode and a receive signal used by the other communication module in standby mode. That is, when the fundamental frequency of a transmit signal used by one communication module is substantially equal to that of a receive signal used by the other communication module, interference may result.

### SUMMARY OF THE INVENTION

The present invention provides a dual-standby mobile terminal and communication method for the same that can avoid interference between a transmit signal used by one communication module in conversation mode and a receive signal used by the other communication module in standby mode.

In accordance with an exemplary embodiment of the present invention, there is provided a communication method for a dual-standby mobile terminal having two communication modules capable of simultaneously connecting to different wireless communication networks, including: checking when a first communication module makes a transition to conversation mode whether a fundamental frequency of a transmit frequency to be used by the first communication module is equal to that of a receive frequency used by a second communication module; and performing, when the two fundamental frequencies are equal to each other, a conversation mode operation with a newly selected transmit frequency for the first communication module, and performing, when the two fundamental frequencies are not equal to each other, a conversation mode operation with the originally selected transmit frequency for the first communication module.

In accordance with another exemplary embodiment of the present invention, there is provided a communication method operable in a communication module of a dual-standby mobile terminal capable of simultaneously connecting to different wireless communication networks, including: sending, when making a transition from standby mode to a conversation mode, a notification indicating a transmit frequency to be used in the conversation mode; and performing, when a transmit frequency change request is received, the conversation mode operation with a newly selected transmit frequency, and performing, when a transmit frequency change request is not received, the conversation mode operation with the original transmit frequency.

In accordance with another exemplary embodiment of the present invention, there is provided a communication method for a first one of two communication modules in a dual-standby mobile terminal capable of simultaneously connecting to different wireless communication networks, comprising: checking, when a notification indicating a transmit frequency used by a second communication module is received during standby mode, whether the fundamental frequency for the transmit frequency is equal to that for a receive frequency used in standby mode; and sending, when the fundamental frequency for the transmit frequency is equal to that of the receive frequency, a change request for the transmit frequency to the second communication module.

In accordance with another exemplary embodiment of the present invention, there is provided a dual-standby mobile terminal including first and second communication modules capable of simultaneously connecting to different wireless communication networks, wherein the first communication module sends, upon making a transition to conversation mode, a notification indicating a transmit frequency to be used in conversation mode, and performs, upon reception of a change request for the transmit frequency, a conversation mode operation with a newly selected transmit frequency, and wherein the second communication module sends the change request when a fundamental frequency of the notified transmit frequency is equal to that of a receive frequency used in standby mode after reception of the notification.

In a feature of the present invention, when the fundamental frequency related to the transmit signal used by a first communication module is equal to or related to the receive frequency used by a second communication module, the dual-standby mobile terminal can change the transmit frequency used by the first communication module. The dual-standby mobile terminal can avoid interference between a transmit signal used by one communication module and a receive signal used by the other communication module. Thus, in the dual-standby mobile terminal, when one of the communication modules is in conversation mode, it is possible to prevent degradation of the reception sensitivity of the other communication module in standby mode.

### BRIEF DESCRIPTION OF THE DRAWINGS

The features and advantages of the present invention will be more apparent from the following detailed description in conjunction with the accompanying drawings, in which:

FIG. 1 is a block diagram illustrating a communication system in accordance with the principles of the present invention;

FIG. 2 is a block diagram of a mobile terminal according to an exemplary embodiment of the present invention;

FIG. 3 is an interaction diagram illustrating a communication method according to another exemplary embodiment of the present invention; and

FIG. 4 is a flow chart illustrating the communication method for the mobile terminal.

### DETAILED DESCRIPTION OF THE INVENTION

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

In the description, the mobile terminal is a dual-standby mobile terminal that can simultaneously connect to at least two wireless communication networks supporting various communication schemes such as Code Division Multiple Access (CDMA), Global System for Mobile communications (GSM), Wideband Code Division Multiple Access (WCDMA), and Wireless Broadband (WiBro). For the purpose of description, it is assumed that the mobile terminal connects to two wireless communication networks at the same time. The present invention may also be applicable to the case where the mobile terminal connects to three or more wireless communication networks at the same time.

The fundamental frequency of a periodic signal is the lowest frequency obtainable through frequency decomposition. Harmonic frequencies or harmonics are integer multiples of the fundamental frequency. That is, when f denotes the fundamental frequency, harmonics are 2×f, 3×f, 4×f, 5×f, etc. However, for purposes of explaining the operation of the invention claimed, the fundamental frequency (i.e., 1×f) is also referred to as a harmonic frequency.

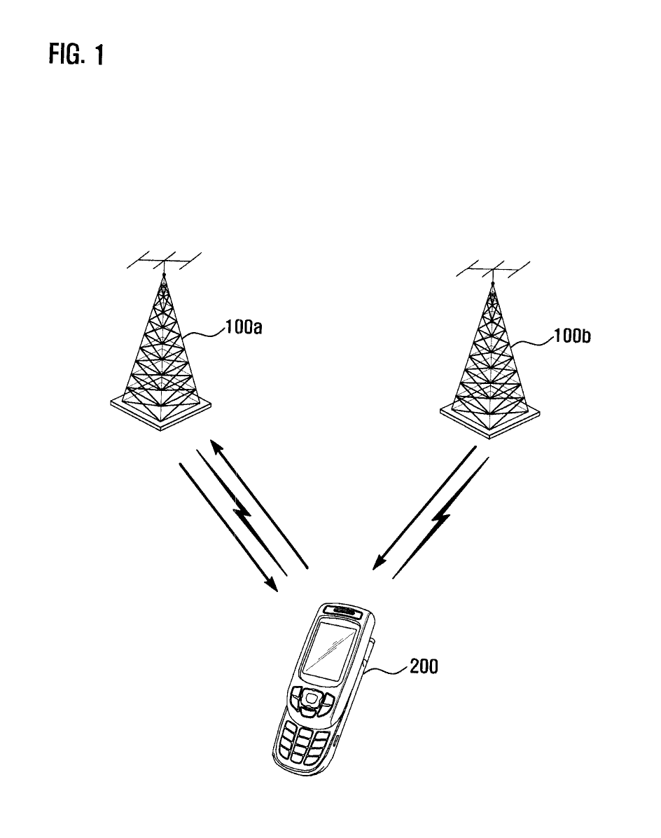

FIG. 1 is a block diagram illustrating a communication system in accordance with the principles of the present invention.

Referring to FIG. 1, the communication system includes a first base station 100a, a second base station 10b, and a mobile terminal 200. The first base station 100a belongs to a first wireless communication network, and the second base station 100b belongs to a second wireless communication network. The mobile terminal 200 can connect to the first and second wireless communication networks at the same time through the first and second base stations 100a and 100b.

During standby mode, the mobile terminal 200 periodically receives signals from the first and second base stations 100a and 100b. Here, the receive frequency in relation to the first base station 100a is different from that in relation to the second base station 10b. The mobile terminal 200 can enter into conversation mode in relation to one of the first and second base stations 100a and 100b. In conversation mode, the mobile terminal 200 sends and receives a signal to and from one of the first and second base stations 100a and 100b. The mobile terminal 200 sends a signal with a given transmit frequency. For example, the mobile terminal 200 can perform a conversation mode operation through the first base station 100a, and perform a standby mode operation through the second base station 10b.

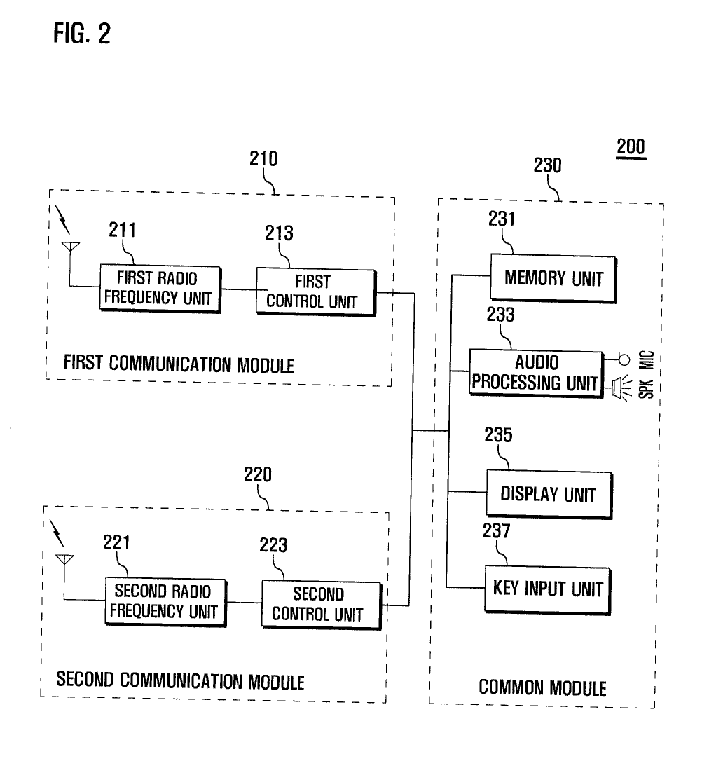

FIG. 2 is a block diagram of a mobile terminal 200 according to an exemplary embodiment of the present invention.

Referring to FIG. 2, the mobile terminal 200 includes a first communication module 210, a second communication module 220, and a common module 230.

The first communication module 210 communicates with the first base station 100a. That is, the first communication module 210 can connect through the first base station 100a to the first wireless communication network. The first communication module 210 includes a first radio frequency unit 211 and a first control unit 213.

The first radio frequency unit 211 transmits a signal of a transmit frequency according to a radio communication protocol of the first wireless communication network, and selectively receives a signal of a receive frequency associated with the first wireless network. The first radio frequency unit 211 includes a radio frequency (RF) transmitter for up-converting the frequency of a signal to be transmitted and amplifying the signal, and an RF receiver for low-noise amplifying a received signal and down-converting the frequency of the received signal.

The first control unit 213 controls the overall operation of the first communication module 210. The first control unit 213 includes a data processing section for encoding and modulating a signal to be transmitted and for demodulating and decoding a received signal. The data processing section may include a modulator/demodulator (modem) and a coder/decoder (codec). The codec includes a data codec for processing packet data, and an audio codec for processing an audio signal such as a voice signal.

When connected through the first radio frequency unit 211 to the first wireless communication network, the first control unit 213 enters into standby mode. During standby mode, the first control unit 213 processes a signal periodically received from the first base station 100a. In response to a communication event during standby mode, the first control unit 213 enters into conversation mode. During conversation mode, the first control unit 213 can perform a conversation mode operation utilizing a transmit frequency according to a radio communication protocol of the first wireless communication network. The first control unit 213 can change the current transmit frequency, and perform a conversation mode operation utilizing another transmit frequency according to the radio communication protocol of the first wireless communication network. That is, the first control unit 213 can control the first radio frequency unit 211 to change the current transmit frequency and to send a signal using another transmit frequency according to the radio communication protocol of the first wireless communication network.

The second communication module 220 communicates with the second base station 10b. That is, the second communication module 220 can connect through the second base station 100b to the second wireless communication network. The second communication module 220 includes a second radio frequency unit 221 and a second control unit 223. The configuration and operation of the second communication module 220 are similar to those of the first communication module 210, and a description thereof is omitted.

The common module 230 is connected to the first communication module 210 and second communication module 220, and performs various operations under the control of one of the first control unit 213 and second control unit 223. The common module 230 includes a memory unit 231, audio processing unit 233, display unit 235, and key input unit 237.

The memory unit 231 may include a program storage section and data storage section. The program storage section stores programs to control the normal operation of the mobile terminal 200. In particular, the program storage section can store a program to control transmit frequencies. The data storage section stores data generated during execution of the programs.

The audio processing unit 233 reproduces through a speaker SPK a reception audio signal from the audio codec of the first or second control unit 213 or 223, and sends a transmit audio signal from a microphone MIC to the audio codec of the first or second control unit 213 or 223.

The display unit 235 displays user data from the first and second control units 213 and 223. The display unit 235 may include a panel of liquid crystal display (LCD) devices, an LCD controller, and a memory device for storing image data. If the panel has a touch screen capability, the display unit 235 can also act as an input means.

The key input unit 237 includes a plurality of keys for inputting alphanumeric data, and a plurality of function keys for setting various functions.

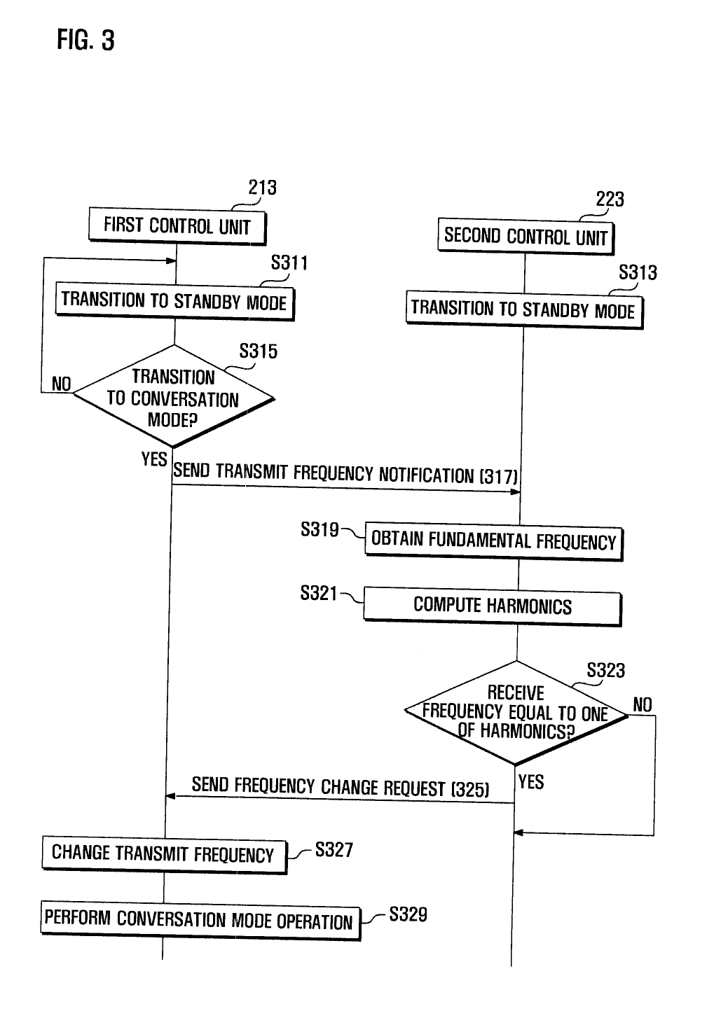

FIG. 3 is an interaction diagram illustrating a communication method according to another exemplary embodiment of the present invention.

Referring to FIG. 3, in the mobile terminal 200 for communication, the first control unit 213 makes a transition to standby mode (S311), and the second control unit 223 makes a transition to standby mode (S313). During standby mode, the first control unit 213 and the second control unit 223 process signals received periodically from the first base station 100a and second base station 100b, respectively.

When the first control unit 213 makes a transition to conversation mode (S315), it sends a transmit frequency notification for conversation mode to the second control unit 223. That is, the first control unit 213 notifies the second control unit 223 of the transmit frequency specified by the radio communication protocol of the first wireless communication network.

The second control unit 223 obtains the fundamental frequency for transmission to the first base station on the basis of the frequency information in the notified transmit frequency message (S319). That is, the second control unit 223 identifies the lowest frequency determinable (obtainable through frequency decomposition) of the transmit frequency. The second control unit 223 computes the harmonics of the fundamental frequency for transmission (S321). That is, the second control unit 223 computes integer multiples of the fundamental frequency (i.e., i×f, where i=1 . . . n). The second control unit 223 determined whether one of the harmonics of the fundamental frequency for transmission to the first base station is equal to or substantially equal to a receive frequency specified by the radio communication protocol of the second wireless communication network (S323). If one of the harmonics of the fundamental frequency is equal to or within a known range of the receive frequency, the second control unit 223 sends a transmit frequency change request to the first control unit 213 (S325).

When a transmit frequency change request is received, the first control unit 213 changes the transmit frequency specified by the radio communication protocol of the first wireless communication network (S327), and performs a conversation mode operation with a newly changed transmit frequency (S329). When a transmit frequency change request is not received, the first control unit 213 performs a conversation mode operation without a transmit frequency change.

In the above procedure, the transmit frequency used by the first communication module 210 is changed depending upon the result of comparison between the harmonics of a transmit signal from the first communication module 210 and the receive frequency used by the second communication module 220. Alternatively, the transmit frequency used by the first communication module 210 may be changed depending upon the result of comparison between the fundamental frequency of a transmit signal related to the first communication module 210 and the fundamental frequency of a receive signal related to the second communication module 220. For example, the second control unit 223 may obtain the fundamental frequency of a receive signal specified by the radio communication protocol of the second wireless communication network at step S321, compare the fundamental frequency of the transmit signal with that of the receive signal at step S323, and send, if the fundamental frequency of the transmit signal is equal to that of the receive signal, a transmit frequency change request at step S325.

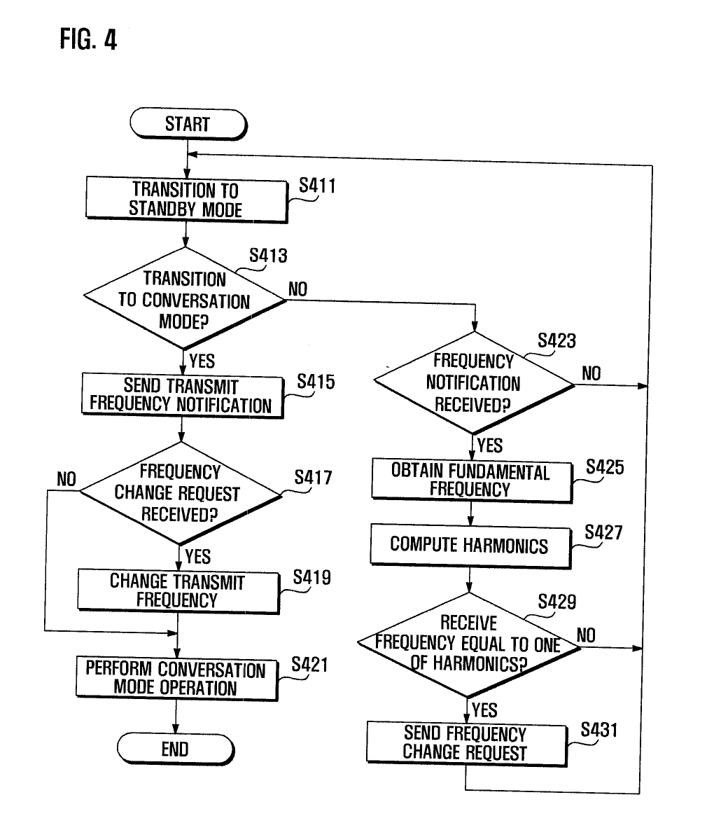

FIG. 4 is a flow chart illustrating the communication method for the mobile terminal. In the description below, a first transmit frequency is a transmit frequency used by one communication module and a second transmit frequency is a transmit frequency used by the other communication module. For example, when the first communication module is in conversation mode, the first transmit frequency is one used by the first communication module and the second transmit frequency is one used by the second communication module.

Referring to FIG. 4, as to the first communication module 210 in the mobile terminal 200, the first control unit 213 makes a transition to standby mode (S411). During standby mode, the first control unit 213 processes a signal received periodically from the first base station 100a.

When a request for conversation mode is issued (S413), the first control unit 213 sends a notification of the first transmit frequency specified by the radio communication protocol of the first wireless communication network (S415). For example, when the first transmit frequency specified by the radio communication protocol of the first wireless communication network is 130 MHz, the first control unit 213 sends a notification informing the second unit that the first wireless communication network is requires transmission on 130 MHz. Upon detection of a communication event during standby mode, the first control unit 213 can make a transition to conversation mode. The first control unit 213 can detect a communication event coming from the first base station 100a, and detect a communication event generated by the user through the key input unit 237.

When a change request for the first transmit frequency is received (S417) by the first control unit 213, the first control unit 213 changes the first transmit frequency (S419). Here, the first control unit 213 changes the first transmit frequency by a preset amount. For example, if the first transmit frequency specified by the radio communication protocol of the first wireless communication network is 130 MHz, the first control unit 213 changes the first transmit frequency to 129 MHz or 131 MHz. Thereafter, the first control unit 213 performs a conversation mode operation (S421). At this step, the first control unit 213 may perform a conversation mode operation with a new first transmit frequency of, for example, 129 MHz or 131 MHz.

When a transmit frequency change request is not received after sending the transmit frequency notification at step S415, the first control unit 213 performs a conversation mode operation with the first transmit frequency (for example, 130 MHz) specified by the radio communication protocol of the first wireless communication network (S421).

When a frequency notification is received by the first control unit during standby mode (S423), the first control unit 213 obtains the fundamental frequency related to the frequency notification (second transmit frequency) (S425). Here, the frequency notification indicates the second transmit frequency specified by the radio communication protocol of the second wireless communication network, and the first control unit 213 identifies the lowest frequency obtainable through frequency decomposition of the second transmit frequency. The first control unit 213 computes the harmonics of the fundamental frequency related to the second transmit frequency (S427). That is, the first control unit 213 computes integer multiples of the fundamental frequency related to the second transmit frequency. This frequency information may be stored in the memory unit 231 in the form of a fundamental-harmonic table as shown in Table 1. That is, the teachings of the present invention discloses that the fundamental frequency is stored in the memory of the mobile terminal as shown in table 1, and the mobile terminal decomposes certain frequencies and determines the fundamental frequency by comparing the fundamental frequency of the memory to the decomposed frequency.

TABLE 1

| Fundamental | | | | |
|---|---|---|---|---|
| frequency | | | | |
| (MHz) | | 104 | 130 | 156 |
| Harmonics | 1st | 104 | 130 | 156 |
| (MHz) | 2nd | 208 | 260 | 312 |
| | 3rd | 312 | 390 | 468 |
| | 4th | 416 | 520 | 624 |
| | 5th | 520 | 650 | 780 |
| | 6th | 624 | 780 | 936 |
| | 7th | 728 | 910 | 1092 |
| | 8th | 832 | 1040 | 1248 |
| | 9th | 936 | 1170 | 1404 |
| | 10th | 1040 | 1300 | 1560 |
| | — | — | — | — |
| | — | — | — | — |

For example, in the case where the second transmit frequency specified by the radio communication protocol of the second wireless communication network is 1300 MHz, the first control unit 213 can identify the second transmit frequency as being 1300 MHz on the basis of a frequency notification message and obtain 130 MHz as the fundamental frequency related to the second transmit frequency The second control unit can then compute a harmonic series including 130 MHz, 260 MHz, 390 MHz, 520 MHz etc, as shown in Table 1.

The first control unit 213 checks whether one of the harmonics of the fundamental frequency related to the second transmit frequency is equal to the receive frequency for standby mode (S429). That is, the first control unit 213 compares each of the harmonics of the second transmit frequency with the receive frequency specified by the radio communication protocol of the first wireless communication network. For example, when the specified receive frequency is 130 MHz, the first control unit 213 checks whether the receive frequency of 130 MHz is equal to one of the harmonics of the second transmit frequency including 130 MHz, 260 MHz, 390 MHz, 520 MHz and the like.

If one of the harmonics of the fundamental frequency related to the second transmit frequency is equal to the receive frequency, the first control unit 213 sends a change request for the second transmit frequency (S431), and returns to step S411 for further processing.

If none of the harmonics of the second transmit frequency are equal to the receive frequency, the first control unit 213 returns to step S411 for further processing.

On the other hand, in the mobile terminal 200, the communication procedure performed by the second communication module 220 is similar to the above described procedure for the first communication module 210, and a description of this similar procedure in the second communication module is omitted. However, in the communication procedure performed by the second communication module 220, the first transmit frequency indicates a transmit frequency used by the second communication module 220, and the second transmit frequency indicates a transmit frequency used by the first communication module 210.

In the above procedure, the second transmit frequency used by the first or second communication module 210 or 220 is changed depending upon the result of the comparison between the harmonics of the second transmit frequency used by the first or second communication module 210 or 220 and the receive frequency used by the first or second communication module 210 or 220. Alternatively, the second transmit frequency used by the first or second communication module 210 or 220 may be changed depending upon the result of comparison between the fundamental frequency related to the second transmit frequency and the fundamental frequency related to the receive frequency. For example, the first or second communication module 210, r 220, respectively, may obtain the fundamental frequency related to the receive frequency at step S427, compare the fundamental frequency related to the second transmit signal with that related to the receive signal at step S429, and send, if the two fundamental frequencies are equal to each other, a transmit frequency change request at step S431.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A communication method for a dual-standby mobile terminal having two communication modules capable of simultaneously connecting to different wireless communication networks, comprising:
checking when a first communication module makes a transition to conversation mode whether a fundamental frequency of a transmit frequency to be used by the first communication module is equal to that of a receive frequency used by a second communication module; and
performing, when the two fundamental frequencies are equal to each other, a conversation mode operation with a newly selected transmit frequency for the first communication module, and performing, when the two fundamental frequencies are not equal to each other, a conversation mode operation with the originally selected transmit frequency for the first communication module.

2. The communication method of claim 1, wherein checking whether the fundamental frequency of the transmit frequency is equal to that of the receive frequency comprises:
sending, by the first communication module upon making a transition to conversation mode, a notification indicating the transmit frequency;
determining, by the second communication module upon reception of the notification, the fundamental frequency for the notified transmit frequency; and
checking, by the second communication module, whether the fundamental frequency for the notified transmit frequency is equal to that of the receive frequency.

3. The communication method of claim 1, wherein the step of checking whether the fundamental frequency of the transmit frequency is equal to that of the receive frequency comprises:
checking whether a harmonic of the fundamental frequency is equal to that of the receive frequency.

4. The communication method of claim 2, wherein performing a conversation mode operation comprises:
sending, by the second communication module when the fundamental frequency for the notified transmit frequency is equal to that of the receive frequency, a change request for the transmit frequency; and
changing, by the first communication module upon reception of the change request, the transmit frequency by a known amount.

5. A communication method operable in a communication module of a dual-standby mobile terminal capable of simultaneously connecting to different wireless communication networks, comprising:
sending, when making a transition from standby mode to a conversation mode, a notification indicating a transmit frequency to be used in the conversation mode;
performing, when a transmit frequency change request is received, the conversation mode operation with a newly selected transmit frequency, and
performing, when a transmit frequency change request is not received, the conversation mode operation with the original transmit frequency.

6. A communication method for a first one of two communication modules in a dual-standby mobile terminal capable of simultaneously connecting to different wireless communication networks, comprising:
checking, when a notification indicating a transmit frequency used by a second communication module is received during standby mode, whether the fundamental frequency for the transmit frequency is equal to that of a receive frequency used in standby mode; and
sending, when the fundamental frequency for the transmit frequency is equal to that for the receive frequency, a change request for the transmit frequency to the second communication module.

7. The communication method of claim 6, wherein checking whether the fundamental frequency for the transmit frequency is equal to that of the current receive frequency comprises:
computing a plurality of harmonic values of the transmit frequency; and
checking whether one of the computed harmonic values is equal to the receive frequency.

8. A dual-standby mobile terminal comprising first and second communication modules capable of simultaneously connecting to different wireless communication networks,
wherein the first communication module sends, upon making a transition to conversation mode, a notification indicating a transmit frequency to be used in conversation mode, and performs, upon reception of a change request for the transmit frequency, a conversation mode operation with a newly selected transmit frequency,
wherein the second communication module sends the change request when a fundamental frequency of the notified transmit frequency is equal to that of a receive frequency used in standby mode after reception of the notification.

9. The dual-standby mobile terminal of claim 8, wherein the second communication module computes a plurality of harmonic values of the notified transmit frequency, and checks whether one of the computed harmonic values is equal to the receive frequency.

10. The dual-standby mobile terminal of claim 8, wherein when a change request corresponding to the notification is not received, the first communication module performs a conversation mode operation with the original transmit frequency.

11. A communication module used in a dual-mode communication module, comprising:
a processor in communication with a memory, the memory including code which when accessed by the processor causes the processor to:
receive a notified frequency message including a transmit frequency value;
determine a plurality of frequency values associated with the transmit frequency value;
determine whether one of the determined frequency values is equal to a frequency associated with a current receive signal; and
transmitting a change notification message when the one of determined frequency values is equal to the frequency associated with a current receive signal.

12. The module of claim 11, wherein said step of determining a plurality of frequency values comprises;
determining a fundamental value associated with said transmit frequency value; and
determining said plurality of frequency values as:
fᵢ=i×f,
where i is an integer value 1 to n; and
f is the determined fundamental value.

13. A dual mode portable terminal comprising:
a first transceiving and processing section;
a second transceiving and processing section; and
a common section in communication with said first and said second transceiving and processing sections, said common section;
receiving an indication of a desired transmit frequency from said first transceiving and processing section and a current receiving frequency from said second transceiving and processing section;
determining a fundamental frequency of said desired transmit frequency;
determining a plurality of frequencies associated with said fundamental frequency, said plurality of frequencies being integer multiples of said fundamental frequency;
determining whether one of said plurality of frequencies associated with said fundamental frequency is equal to said current receiving frequency; and
altering said transmit frequency by a known amount when one of said plurality of frequencies associated with said fundamental frequency is equal to said current receiving frequency.

14. The terminal according to claim 13, wherein said common section further comprises;
a processor in communication with a memory, the memory including code which is accessed by the processor.

15. The terminal according to claim 13 further comprising:
a display unit for displaying at least said transmit frequency.

16. The terminal according to claim 13 further comprising:
an input unit.
